(19) United States
(12) Patent Application Publication
(10) Pub. No.: US 2011/0052012 A1
(43) Pub. Date: Mar. 3, 2011

(54) Security and Monetization Through Facial Recognition in Social Networking Websites

(75) Inventors: Manik Bambha, Agoura Hills, CA (US); Thomas Anderson, Los Angeles, CA (US); Steven Pearman, Beverly Hills, CA (US); Vincent Roussilhon, San Francisco, CA (US)

(73) Assignee: MYSPACE INC., Beverly Hills, CA (US)

(21) Appl. No.: 12/752,106

(22) Filed: Mar. 31, 2010

Related U.S. Application Data
(60) Provisional application No. 61/165,127, filed on Mar. 31, 2009.
(60) Provisional application No. 61/165,120, filed on Mar. 31, 2009.

(51) Int. Cl. G06K 9/00

(52) U.S. Cl. 382/118

(57) ABSTRACT

A method of facial feature recognition at an image hosting website includes receiving an image, processing the received image at a recognition server to identify features and/or people, determining at least one of, a targeted ad based on the identified features, and a comparison the identified features in the image to images in an image database, and driving a security measure or targeted ad in response to the determining.

### CROSS REFERENCE TO RELATED APPLICATIONS

This application claims priority under 35 U.S.C. §119 to U.S. Provisional Application No. 61/165,127 filed Mar. 31, 2009 and to U.S. Provisional Application No. 61/165,120 filed Mar. 31, 2009; there entire contents of both Provisional Applications are hereby incorporated by reference in their entirety.

### TECHNICAL FIELD

The present invention is generally related to image hosting websites and/or social networking websites. More particularly, example embodiments of the present invention are directed to the use of facial recognition for security and monetization in image hosting websites and/or social networking websites.

### BACKGROUND OF THE INVENTION

Conventionally, social networking websites allow users to upload photographs for storage and sharing through user accounts. For example, a user may upload pictures of friends, family, and/or themselves. Through the use of facial and/or optical recognition, particular features of the photographs may be isolated and processed for security measures and/or monetization.

### BRIEF DESCRIPTION OF THE INVENTION

According to example embodiments, a method of facial feature recognition at an image hosting website includes receiving an image, processing the received image at a recognition server to identify features and/or people, determining at least one of, a targeted ad based on the identified features, and a comparison the identified features in the image to images in an image database, and driving a security measure or targeted ad in response to the determining.

According to example embodiments, a computer readable storage medium includes computer executable instructions, that, if executed by a computer processor of a computer apparatus, direct the computer processor to implement a method of facial feature recognition at an image hosting website. The method includes receiving an image, processing the received image at a recognition server to identify features and/or people, determining at least one of, a targeted ad based on the identified features, and a comparison the identified features in the image to images in an image database, and driving a security measure or targeted ad in response to the determining.

According to example embodiments, a system for facial feature recognition of an image hosting website includes a user terminal and the image hosting website in operative communication with the user terminal, the image hosting website disposed to receive images uploaded from the user terminal, to the image hosting website. The system further includes a recognition server in operative communication with the image hosting website, the recognition server disposed to receive and recognize features of images received from the image hosting website. The system further includes an advertisement server in operative communication with the image hosting website, the advertisement server disposed to receive a plurality of recognized features from the image hosting website and to produce at least one targeted advertisement to the image hosting website based on the received plurality of recognized features.

These and other features of the present invention will be better appreciated by reference to the appended drawings and the description which follows.

### BRIEF DESCRIPTION OF THE DRAWINGS

Many aspects of the invention can be better understood with reference to the following drawings. The components in the drawings are not necessarily to scale, emphasis instead being placed upon clearly illustrating the principles of the present invention. Moreover, in the drawings, like reference numerals designate corresponding parts throughout the several views. Furthermore, each drawing contained in this provisional application includes at least a brief description thereon and associated text labels further describing associated details. The figures:

FIG. 1 illustrates an example web browser interface;

FIG. 2 illustrates an example web browser interface including a targeted advertisement;

FIG. 3 illustrates an example web browser interface;

FIG. 4 illustrates a web browser with a targeted advertisement, according to an example embodiment;

FIG. 5 illustrates a security and monetization system, according to an example embodiment;

FIG. 6 illustrates a feature recognition method, according to an example embodiment; and

FIG. 7 illustrates an example computer/server apparatus, according to an example embodiment.

### DETAILED DESCRIPTION

Detailed illustrative embodiments are disclosed herein. However, specific functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

It will be understood that, although the terms first, second, etc. may be used herein to describe various steps or calculations, these steps or calculations should not be limited by these terms. These terms are only used to distinguish one step or calculation from another. For example, a first calculation could be termed a second calculation, and, similarly, a second step could be termed a first step, without departing from the scope of this disclosure. As used herein, the term “and/or” includes any and all combinations of one or more of the associated listed items.

It will also be understood that the terms “photo,” “photograph,” “image,” or any variation thereof may be interchangeable. Thus, any form of graphical image may be applicable to example embodiments.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

Further to the brief description provided above and associated textual detail of each of the figures, the following description provides additional details of example embodiments of the present invention.

Embodiments are directed to methods of utilizing facial/feature recognition to implement security measures through an image hosting and/or social networking website. For example, an image owner (i.e., MYSPACE user) may post a plurality of images to a website, each image being associated with the user. Any given image may include people who raise security concerns. For example, known felons, criminals, or child predators may be included in any of the images. Through facial/feature recognition, these people may be identified and appropriate action may be taken by the image hosting/social networking website. For example, the user's account may be suspending or locked, the images may be removed, and/or communication to other users (for example minors) may be halted and/or restricted.

Other example embodiments may be directed to methods of utilizing facial/feature recognition to target advertisements to an owner of an image through an image hosting website. For example, an image owner (i.e., MYSPACE user) may post a plurality of images to a website, each image being associated with the owner. Any given image may include a picture of either the owner or people associated with the owner. For example, a picture may include the owner, a significant other, children, etc. Depending upon the particular features identified through facial/feature recognition of an image, advertisements may be filtered and may be more customized for the image owner. For example, advertisements intended for parents may be fed to the owner upon recognition of children, advertisements for medications or products intended for a particular ethnic group may be fed to the owner upon recognition of a particular ethnicity, et cetera.

The processing of uploaded photos may be launched during the uploading process. It may be desirable to perform processing in parallel to the uploading/resizing such that it does not increase the uploading time. To save resources, the processing may occur after thumbnails have been created and may be applied to a large size thumbnail (e.g., 600 p×width) instead of the original (for example, if originally sized images are not stored on the image-hosting website).

With regards to existing photos, if a user signs on for the feature to process old photos, a processor may begin to gradually process all existing photos already hosted on the image hosting website. The newest photos may be processed first, with older photos afterward. In this manner, older content that is less used will be processed later. This may be desirable because a user's interests may change over time, therefore, older photos processed for targeted advertising may be less effective than newer photos. Furthermore, a user's facial features or updated photos of felons or criminals as described above may change over time, thus more recent images may prove more useful in implementing security actions.

With regards to the information to extract, examples may include faces for facial recognition, a number of faces, a position of each face, specific attributes of each face (used for matching faces with an image database, for example, a law enforcement database), number of males/females, number of children/babies, ethnicity of people, people wearing glasses/goggles, and/or any other suitable information. As noted, any other information suitable may also be extracted, and thus these examples should not be considered as limiting.

Hereinafter, a more detailed description of example embodiments is provided with reference to the different figures.

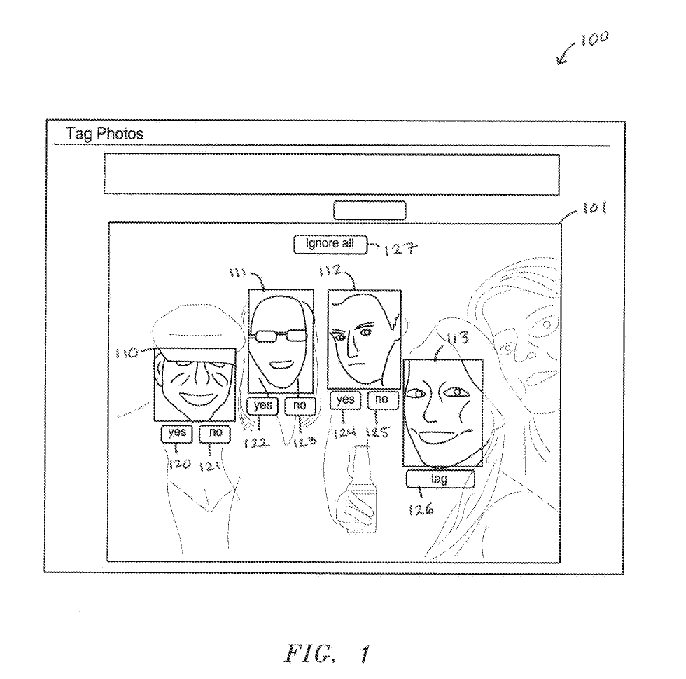

FIG. 1 illustrates an example browser interface/diagram 100 depicting an uploaded photograph. During the uploading process, or at significantly the same time, image processing may be executed of an uploaded image 101. Individual faces/people (110, 111, 112, 113) may be processed individually or in parallel. As different features (e.g., as noted in examples above) are identified, a targeted advertising engine/server may determine a desired ad to drive to the user. For example, in FIG. 1 a plurality of female persons may be identified in the uploaded photograph. It follows that a desired targeted ad may include an ad directed towards females or groups of females.

In addition to targeted advertising, the facial features identified for faces 110-113 may be compared to any image database in operative communication with a server including the uploaded image. For example, any one of the faces 110-113 may be matched, using facial feature recognition, to images contained in a law enforcement database. Thereafter, an appropriate or suitable action may be taken. For example, a user's account may be modified, suspended, or otherwise halted. Also, or additionally, a report may be issued and the user may be notified of the match from the uploaded image.

In further addition to targeted advertising, automatic tagging of the image may be facilitated through facial feature recognition. For example, any of the faces 110-113 may be matched to existing, tagged images for the uploading user. The user may be prompted through user interface elements 120-127 to automatically tag or manually tag each face 110-113.

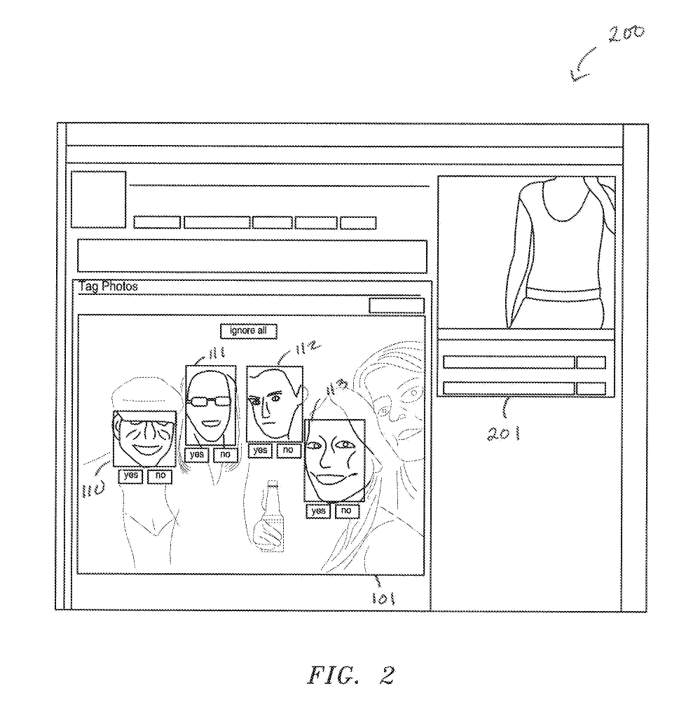

Turning now to FIG. 2, an example browser diagram 200 depicting the uploaded photograph of FIG. 1 and a targeted ad is illustrated. As discussed previously, the targeted ad 201 may be directed to females or groups of females. Thus, the targeted ad illustrated in FIG. 2 includes an advertisement related to female interests. It is noted that this targeted ad illustrated is for example purposes only, and should not be construed as limiting. Any suitable ad may be driven through facial and/or feature recognition. For example, face 110 includes a hat/visor. Therefore, an advertisement for clothing may be driven. Furthermore, face 111 includes eye-wear. Therefore, an advertisement for an optician or for eye-wear may be driven. It follows that although a single advertisement 201 is illustrated, a plurality of ads may be driven sequentially or at one time.

For example, additional user interface elements displaying ads may include separate ads directed to one or more identified faces/features. Also, an advertisement banner with different ads displayed at different times may be driven depending upon a presently selected face. For example, if a user is inserting a tag or data associated with one face 110, targeted ad 201 may be directed to features related to face 110. Upon completion of data insertion, the user may begin to insert a tag or data associated with face 111. At substantially the same time, or during any phase of selection/data entry, targeted ad 201 may be directed to features related to face 111.

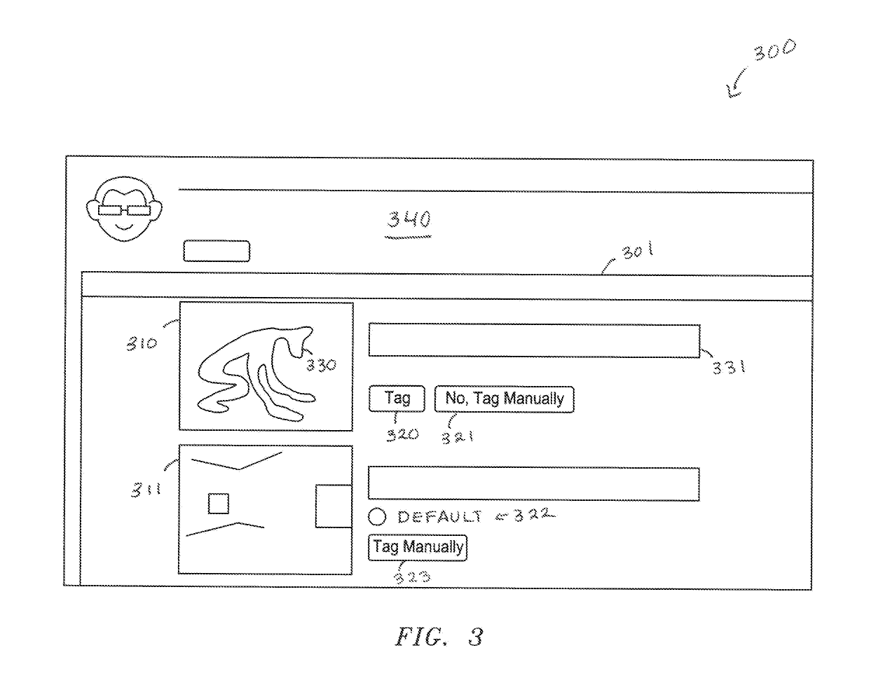

Turning to FIG. 3, an example browser diagram 300 depicting a plurality of uploaded photographs and a targeted banner-style ad is illustrated. For example, photographs 310 and 311 may be uploaded by a user through browser interface portion 301. Thereafter, a feature 330 may be identified and may be used to drive banner ad 340. For example, feature 330 may be a landmark at a tourist or vacation destination. It follows that banner ad 340 may be directed to a travel agency or travel savings. Also, as described above, automatic tagging and/or security features may be implemented. For example, feature 330 may be automatically tagged with data from field 331 using user interface elements 320-321. Additionally, if no features are identified (see 311), a default tag or data caption 322 may be used, or a user may tag the image 311 manually using user interface element 323.

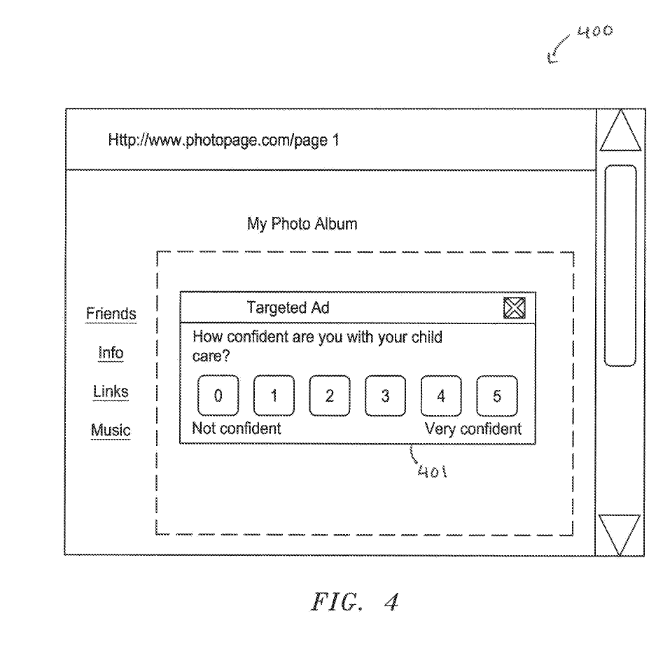

As a more generic example, FIG. 4 is presented herein. FIG. 4 includes an example embodiment only, and thus should not be construed as limiting.

FIG. 4 depicts an example image hosting site webpage diagram 400 with a targeted ad 401. A user may have uploaded a photo of their children (not illustrated) into the image hosting site. Upon recognition, the targeted ad 401 may be driven to the user. For example, users upload photos onto image hosting websites such as MYSPACE to share with friends/family. These pictures and their contents provide key information pertaining to the user. For example, whether the user has a large family, is of a particular ethnicity, has children, etc. For example, if a user has children, there may be a chance that said user is interested in childcare or other child related services/goods. In addition, said user may be more interested in purchasing child related products. Therefore, it follows that a good, targeted ad may include child related items, such as childcare, toys, etc.

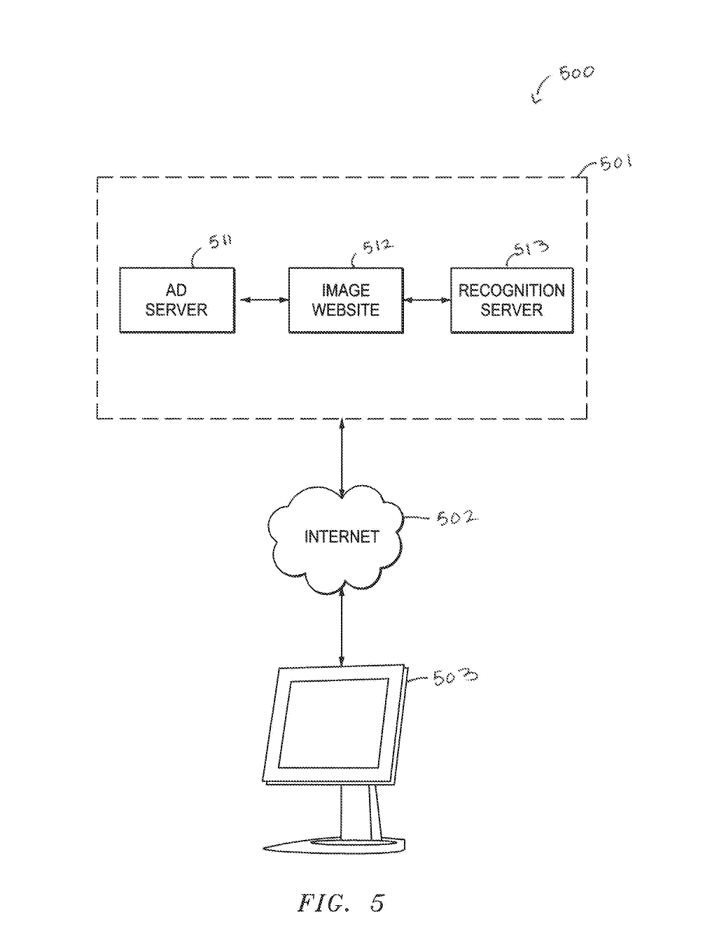

FIG. 5 depicts an example system 500 that may be used according to the example embodiments described herein. As illustrated, the system includes a server grouping or hosting 501 which includes a recognition server 513, an image hosting site server 512, and a targeted advertising server 511. The recognition server 513 may process uploaded photos from the image-hosting server 512 for identification of the features described above. This information may be communicated to the targeted ad server 511 such that desirable ads are determined. Further, these targeted ads may be communicated to the image-hosting server 512 such that they are driven to a user connected to the image-hosting server 512. The user may be connected to the image-hosting server 512 through the Internet 502 or any other suitable communication medium using a computer apparatus 503.

Although an advertising server 511 is illustrated, it is noted that a law enforcement database or known security risk database may also be included. For example, the image-hosting server 512 may be in operable communication with a law enforcement database. As the recognition server 513 identifies features from an image, these features may be matched within the law enforcement database to determine if any known offenders are included in the image. Thereafter, appropriate action may be taken.

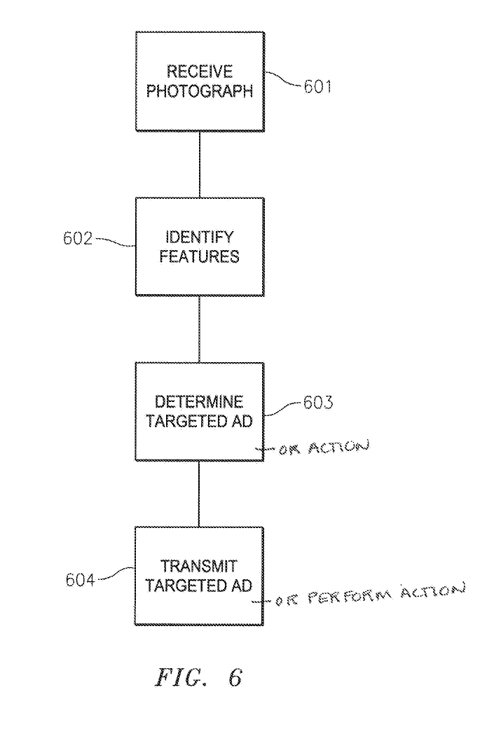

Turning now to FIG. 6, an example methodology is illustrated. The method may include receiving a photograph at block 601. The photograph may be uploaded by a user of an image-hosting site, to the image-hosting site, such that the image may be processed through the image-hosting site. For example, a user may select an image to be uploaded, and may transmit the image from a computer apparatus to the image hosting website.

The method further includes processing the received photograph at block 602. For example, the photograph may be processed at a recognition server/computer to identify features. The features may include the features described above, or any other suitable features.

The method further includes determining at least one targeted ad based on the identified features, or determining an appropriate action at block 603. For example, the features may be communicated to a targeted advertising server/computer such that desirable advertisements are determined. Each identified feature may be compared to a set of advertisements, and based on this comparison, one or more targeted ads may be identified.

Alternatively, the features may be communicated to a law enforcement database such that appropriate actions may be determined. For example, the features of individual faces may be compared to features contained in the law enforcement database to determine if there is a match. The database may also be a database of the image hosting website. For example, containing suspended users or other information.

The method further includes driving the at least one targeted ad in response to the determining, or performing the determined action at block 604.

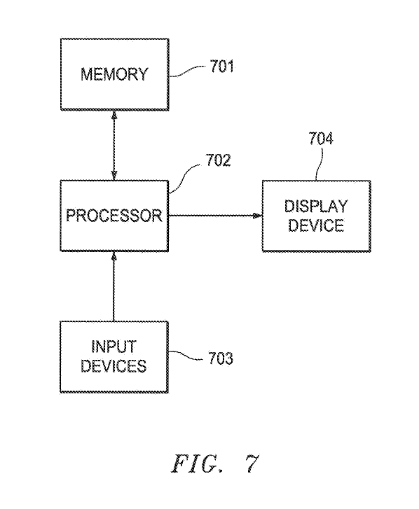

Furthermore, according to an exemplary embodiment, the methodologies described hereinbefore may be implemented by a computer system or apparatus. For example, FIG. 7 illustrates a computer apparatus, according to an exemplary embodiment. Therefore, portions or the entirety of the methodologies described herein may be executed as instructions in a processor 702 of the computer system 700. The computer system 700 includes memory 701 for storage of instructions and information, input device(s) 703 for computer communication, and display device 704. Thus, the present invention may be implemented, in software, for example, as any suitable computer program on a computer system somewhat similar to computer system 700. For example, a program in accordance with the present invention may be a computer program product causing a computer to execute the example methods described herein.

The computer program product may include a computer-readable medium having computer program logic or code portions embodied thereon for enabling a processor (e.g., 702) of a computer apparatus (e.g., 700) to perform one or more functions in accordance with one or more of the example methodologies described above. The computer program logic may thus cause the processor to perform one or more of the example methodologies, or one or more functions of a given methodology described herein.

The computer-readable storage medium may be a built-in medium installed inside a computer main body or removable medium arranged so that it can be separated from the computer main body.

Further, such programs, when recorded on computer-readable storage media, may be readily stored and distributed. The storage medium, as it is read by a computer, may enable the method(s) disclosed herein, in accordance with an exemplary embodiment of the present invention.

Therefore, the methodologies and systems of example embodiments of the present invention can be implemented in hardware, software, firmware, or a combination thereof. Embodiments may be implemented in software or firmware that is stored in a memory and that is executed by a suitable instruction execution system. These systems may include any or a combination of the following technologies, which are all well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Any process descriptions or blocks in flow charts should be understood as representing modules, segments, or portions of code which include one or more executable instructions for implementing specific logical functions or steps in the process, and alternate implementations are included within the scope of at least one example embodiment of the present invention in which functions may be executed out of order from that shown or discussed, including substantially concurrently or in reverse order, depending on the functionality involved, as would be understood by those reasonably skilled in the art of the present invention.

Any program which would implement functions or acts noted in the figures, which comprise an ordered listing of executable instructions for implementing logical functions, can be embodied in any computer-readable medium for use by or in connection with an instruction execution system, apparatus, or device, such as a computer-based system, processor-containing system, or other system that can fetch the instructions from the instruction execution system, apparatus, or device and execute the instructions. In the context of this document, a “computer-readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM or Flash memory) (electronic), an optical fiber (optical), and a portable compact disc read-only memory (CDROM) (optical). Note that the computer-readable medium could even be paper or another suitable medium, upon which the program is printed, as the program can be electronically captured, via for instance optical scanning of the paper or other medium, then compiled, interpreted or otherwise processed in a suitable manner if necessary, and then stored in a computer memory. In addition, the scope of the present invention includes embodying the functionality of the preferred embodiments of the present invention in logic embodied in hardware or software-configured mediums.

It should be emphasized that the above-described embodiments of the present invention, particularly, any detailed discussion of particular examples, are merely possible examples of implementations, and are set forth for a clear understanding of the principles of the invention. Many variations and modifications may be made to the above-described embodiment(s) of the invention without departing substantially from the spirit and principles of the invention. All such modifications and variations are intended to be included herein within the scope of this disclosure and the present invention and protected by the following claims.

1. A method of facial feature recognition at an image hosting website, comprising:
receiving an image;
processing the received image at a recognition server to identify features and/or people;
determining at least one of,
a targeted ad based on the identified features, and
a comparison the identified features in the image to images in an image database; and
driving a security measure or targeted ad in response to the determining.

2. The method of claim 1, wherein receiving the image includes:
accessing the image hosting website;
selecting the at least one image at a computer apparatus in operative communication with the image hosting website; and
uploading the image, from the computer apparatus, to the image hosting website.

3. The method of claim 2, wherein the computer apparatus is a personal digital assistant (PDA), a personal computer, a cellular telephone, a notebook computer, or a portable computing device.

4. The method of claim 1, wherein the determining the targeted ad includes:
comparing the identified features to a set of advertisements; and
retrieving an advertisement based on the comparison.

5. The method of claim 4, wherein a plurality of advertisements are retrieved based on the comparison.

6. The method of claim 5, wherein driving the targeted ad includes displaying at least one of the plurality of advertisements to a user owning the received image.

7. The method of claim 4, wherein comparing the identified features includes:
comparing each identified feature to an advertisement of the set of advertisements; and
matching at least one identified feature to at least one advertisement.

8. The method of claim 7, wherein the identified feature is one of a number of faces in the received image, a position of each face in the received image, specific attributes of each face, a number of males and/or females in the received image, a number of children in the received image, ethnicity of people in the received image, a geographical landmark in the received image, and people wearing eye-wear in the received image.

9. The method of claim 1, wherein determining a comparison of identified features includes:
comparing identified features of individual people of the received image to features of individual people stored in an image database.

10. The method of claim 9, wherein the image database is a known-criminal database, a law-enforcement database, or a database of the image hosting website.

11. A computer readable storage medium containing computer executable instructions, that, if executed by a computer processor of a computer apparatus, direct the computer processor to implement a method of facial feature recognition at an image hosting website, the method comprising
receiving an image;
processing the received image at a recognition server to identify features and/or people;
determining at least one of,
a targeted ad based on the identified features, and
a comparison the identified features in the image to images in an image database; and
driving a security measure or targeted ad in response to the determining.

12. The computer readable storage medium of claim 11, wherein receiving the image includes:
accessing the image hosting website;
selecting the at least one image at a second computer apparatus in operative communication with the image hosting website; and
uploading the image, from the second computer apparatus, to the image hosting website.

13. The computer readable storage medium of claim 12, wherein the second computer apparatus is a personal digital assistant (PDA), a personal computer, a cellular telephone, a notebook computer, or a portable computing device.

14. The computer readable storage medium of claim 11, wherein the determining the targeted ad includes:
comparing the identified features to a set of advertisements; and
retrieving an advertisement based on the comparison.

15. The computer readable storage medium of claim 14, wherein a plurality of advertisements are retrieved based on the comparison.

16. The method of claim 15, wherein driving the targeted ad includes displaying at least one of the plurality of advertisements to a user owning the received image.

17. The computer readable storage medium of claim 14, wherein comparing the identified features includes:
comparing each identified feature to an advertisement of the set of advertisements; and
matching at least one identified feature to at least one advertisement.

18. The computer readable storage medium of claim 17, wherein the identified feature is one of a number of faces in the received image, a position of each face in the received image, specific attributes of each face, a number of males and/or females in the received image, a number of children in the received image, ethnicity of people in the received image, a geographical landmark in the received image, and people wearing eye-wear in the received image.

19. The computer readable storage medium of claim 11, wherein determining a comparison of identified features includes:
comparing identified features of individual people of the received image to features of individual people stored in an image database, wherein the image database is a known-criminal database, a law-enforcement database, or a database of the image hosting website.

20. A system for facial feature recognition of an image hosting website, comprising:
a user terminal;
the image hosting website in operative communication with the user terminal, the image hosting website disposed to receive images uploaded from the user terminal, to the image hosting website;
a recognition server in operative communication with the image hosting website, the recognition server disposed to receive and recognize features of images received from the image hosting website; and
an advertisement server in operative communication with the image hosting website, the advertisement server disposed to receive a plurality of recognized features from the image hosting website and to produce at least one targeted advertisement to the image hosting website based on the received plurality of recognized features.
